(19) United States
(12) Patent Application Publication
(10) Pub. No.: US 2008/0247280 A1
(43) Pub. Date: Oct. 9, 2008

(54) Optical Drive with Constant Radial Bandwidth

(76) Inventor: Johannes Leopoldus Bakx, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/063,686

(22) PCT Filed: Aug. 16, 2006
(86) PCT No.: PCT/IB2006/052821

§ 371 Date: Feb. 13, 2008

(30) Foreign Application Priority Data
Aug. 16, 2005 (EP) 05107499.5

(51) Int. Cl. G11B 7/00

(52) U.S. Cl. 369/44.13

(57) ABSTRACT

The invention relates to an optical drive for e.g. CD, DVD, HD-DVD or BD disks. A radial servomechanism controls the radial position of a laser beam in response to a push pull signal (PP). The radial servomechanism has an amplifier (VGA, 55) with a variable gain (G). The drive contains wobble signal detection means (51, 52, 53) so as to provide an amplitude (WA) of the wobble signal from the push pull signal (PP). Transition detection means (54) assesses if the focused radiation beam is or has been exposed to a change in a local optical environment on the optical carrier, such a read-write transition. In case of a transition, the radial servo gain (G) is adjusted in dependence of a ratio (r) of a wobble amplitude (WA_b) just before said transition to a wobble amplitude (WA_a) just after said transition so as to obtain a substantially constant radial bandwidth of the radial servomechanism.

The present invention relates to an optical drive capable of recording and/or reproducing data or information to an optical carrier, e.g. a CD, DVD, HD-DVD or BD disk. More specifically, the invention may provide a substantially constant radial bandwidth of an optical drive's radial servomechanism. The invention also relates to a corresponding method for operating an optical drive.

In optical drives for recording and reproducing of information or data from an optical disk, e.g. a CD, a DVD, or a BD, a servo system is applied for keeping a focused beam of e.g. laser light from an optical pickup unit (OPU) on a desired track of the optical disk. The servo system allows the laser light to accurately follow the tracks on the optical disk to ensure a reliable recording of data in the tracks or a stable readout of data from the tracks.

Specifically, radial tracking is performed based on a closed control loop that uses a radial error signal (RE), i.e. a measure of the deviation of the actual radial position of the laser light from a target radial position, obtained from reflected light of the optical disk. A few well known methods include the push pull (PP) method for rewriteable/recordable optical disks with guide grooves, so-called pre-grooves, and the differential phase detection (DPD) method for optical disks of the read-only memory (ROM) format.

The optical drive typically comprises a focusing lens that is movable by a bi-axial fine-tuning actuator in a focusing direction and in a radial direction for adjusting, respectively, the focal position and the radial position of the laser light on the optical disk. Thus, the radial servomechanism constituted by the optical disk and the said radial actuator and the control means necessary for generating and analyzing the radial error (RE) signals and generating the appropriate control signals to the radial actuator is a dynamic control system that needs to be understood for stable and reliable operation of the optical drive.

Like most physical control systems the radial servomechanism has a well-known low pass behavior as frequency response. Thus, an optical drive may be characterized by a certain radial bandwidth, typically in the order of 10 kHz for e.g. high-speed DVD and high-speed modes like 48× CD and 4× BD, above which the radial servomechanism is unstable. The required radial bandwidth of the servo loop depends on the specifications of the optical disk, the allowed residual error during reading/writing, the eccentricity and accelerations error of the disk, the rotational speed of the disk in the drive etc. As the allowed residual error is related to the track pitch on the disk, the allowed residual error of the radial position on the disk has been constantly decreasing over time which—in turn—requires a higher and higher radial bandwidth, the radial bandwidth being a measure of the speed of response of the radial control system.

However, the achievable radial bandwidth is limited by the mechanical design of the optical drive; i.e. the effective spring and damping constants of the radial actuator configuration, and hence an accurate setting of the gain is required to obtain a stable loop. The radial bandwidth of the radial servomechanism is also dependent on the amplitude of the radial error (RE) signal. Thus, for varying magnitude of the radial error (RE) signal, even if normalized to the total reflected light from the disk, the overall loop gain may change which causes an undesirable change in the radial bandwidth.

In US patent application US 2002/0101797, a solution to this technical problem is disclosed. In short, this solution in real-time suppresses loop gain variations due to difference in the intensity of the reflected light or in intensity distributions by extracting wobble signals, in particular wobble amplitudes, from the push pull (PP) signals continuously and comparing the wobble signals to initial values of the wobble signal that are stored. The initial value of the wobble signal is measured during an initializing procedure before recording or reproduction takes place. By comparing the initial value of the wobble signal amplitude with the present wobble signal amplitude an adjustment of the variable gain of the tracking servo loop is performed. However, this solution of normalizing the loop gain by the wobble signal is silent regarding the fact that the wobble signal is typically quite unstable (amplitude variations up to a factor of 2) due to crosstalk interference of neighboring tracks having a slightly different wobble phase. This is known as the “wobble beat” problem, and it effectively renders a solution based on continuous bandwidth control unfeasible even though normalization is performed.

Hence, an improved optical drive would be advantageous, and in particular a more stable and/or reliable radial bandwidth adaptation of the optical drive during operation would be advantageous.

Accordingly, the invention preferably seeks to mitigate, alleviate or eliminate one or more of the above mentioned disadvantages singly or in any combination. In particular, it may be seen as an object of the present invention to provide an optical drive that solves the above-mentioned problems of the prior art with an unstable and/or varying radial bandwidth because of a changing effective loop gain.

This object and several other objects are obtained in a first aspect of the invention by providing an optical drive capable of recording/reproducing data to/from an associated optical carrier, said optical carrier comprising data tracks with meandering pre-grooves adapted for generating wobble signals, the optical drive comprising:

control means capable of positioning a focused radiation beam on the optical carrier,

photo detection means for detection of radiation reflected from the optical carrier, said photo detection means being adapted for generating a push pull signal (PP) indicative of a difference between a target position and an actual position of the focused radiation beam on the optical carrier,

a radial servomechanism adapted to change the radial position of the focused radiation beam on the optical carrier in response to said push pull signal (PP), said radial servomechanism comprising amplification means for amplifying said push pull signal by a variable gain (G),

wobble signal detection means adapted to obtain an indication of the amplitude (WA) of the wobble signal from the push pull signal (PP), and

transition detection means capable of assessing if the focused radiation beam has been exposed or will be exposed to a change in a local optical environment on the optical carrier,

wherein the optical drive, upon an indication of a transition by the transition detection means, is adapted to change the radial servo gain (G) in dependence of a ratio (r) between a wobble amplitude (WA_b) within a predetermined timeframe (T1) just before said transition and a wobble amplitude (WA_a) within a predetermined timeframe (T2) just after said transition so as to obtain a substantially constant radial bandwidth of the radial servomechanism.

The invention is particularly but not exclusively advantageous for obtaining an optical drive that is capable of adjusting the radial servo gain (G) in an adaptive manner that effectively keeps the radial bandwidth of the radial servomechanism constant during operation. This provides the advantage that the highest possible carrier speed can be obtained under the given mechanical limitations of the optical drive. Preliminary estimates show that it may be possible to increase the carrier speed by at least a factor 2.

Mathematically, the ratio (r) may be defined as

r=WA_{—}b/WA_{—}a. (1)

Thus, the ratio (r) is defined as the ratio of a wobble amplitude (WA_b) within a predetermined timeframe (T1) just before said transition to a wobble amplitude (WA_a) within a predetermined timeframe (T2) just after said transition. Accordingly, the relationship between the gain of the radial servomechanism may be defined as

G=G(r), (2)

i.e. the gain (G) after the transition detected by the transition detection means is a function of the ratio defined in equation (1). As seen from equation (1) it may not be necessary to obtain knowledge of the exact value of the wobble amplitudes before (WA_b) and after (WA_a). Rather, it is possible for some embodiments of the invention to obtain the ratio (r) based on a relative change of the wobble amplitudes before (WA_b) and after (WA_a), thus it may not be necessary to obtain the values themselves. Thus, for example a signal proportional to a wobble amplitude may be exploited to obtain knowledge of a relative change of a wobble amplitude.

While prior art, vide supra, have reported to have the same or similar object as the present invention, it has hitherto not been possible to overcome the aforementioned “wobble beat” problem because continuously monitoring the wobble signal, and adjusting the radial loop gain accordingly, has resulted in unwanted variations or oscillations of the radial bandwidth. However, the variations from the “wobble beat” of the wobble signal are effectively avoided according to the present invention because the optical drive measures the variation of the wobble signal just before and after the transition that requires an adjustment of the radial servo gain (G) instead of a continuous or semi-continuous approach depending on the sampling rate of the wobble signal. Rather, the present invention samples the wobble signals, in particular the wobble amplitudes, within a pre-defined time that is much shorter than the time scale for significant changes of the wobble signal.

Within the context of the present invention it is therefore to be understood that the ratio (r) between a wobble amplitude (WA_b) just before said transition and a wobble amplitude (WA_a) just after said transition is determined relatively fast compared to time scales for significant changes of the wobble signal. However, as long as the time scale of determination of the wobble amplitudes are sufficiently short it may be possible to vary or extend the time scale of determination e.g. for purposes of averaging or other similar measures to increase the quality of the obtained wobble amplitude. Accordingly, the term “just after” and “just before” the transition are not to be considered as being exclusively limited to an interpretation of meaning “immediately after” or “immediately before”. In fact, it is contemplated that for some embodiments it may be beneficial to have a small time delay after the transition before measuring the wobble amplitude in order to avoid transients in the wobble signal resulting from the transition in the local optical environment experienced by the radiation beam on the carrier. Thus, at a read/write transition it may take a laser control loop some time to reach a stable write power. Therefore a so-called hold-off time may advantageously be introduced in the wobble signal measurement.

Advantageously, the adjusted radial servo gain (G_a) after said transition may be substantially equal to the servo gain (G_b) before said transition multiplied by the said ratio (r). Thus, the adjustment may be expressed as

G_{—}a=(WA_{—}b/WA_{—}a)*G_{—}b. (3)

Alternatively, a table may be applied to translate values of r=WA_b/WA_a into values of G_a. In particular, it may be advantageous to have a slowly saturating radial bandwidth so as to avoid a hard-clipping radial bandwidth, i.e. a high order transition of the frequency response.

In a particular embodiment, the adjusted radial servo gain (G_a) after said transition may be further adjusted to be smaller than an upper limit value of the radial servo gain (G_max). Thereby, over-adjustment of the gain that may lead to an unstable behavior of the optical drive is avoided. Similarly, the adjusted radial servo gain (G_a) after said transition may be further adjusted to be larger than a lower limit value of the radial servo gain (G_min) in order to avoid the servo gain being too low. A minimum level of the radial servo gain may be required to cope appropriately with external shocks on the optical drive.

Beneficially, the transition detection means may receive an indication that the focused radiation beam will be exposed to a change in the local optical environment on the optical carrier initiated by the optical drive itself. Thus, by e.g. a write-read transition initiated by the drive itself, a corresponding signal may also be transmitted to the transition detection means that a transition is forthcoming.

Alternatively, the transition detection means may receive an indication that the focused radiation beam has been exposed to a change in the local optical environment on the optical carrier from a relative change in the radiation reflected from the optical carrier. Thus, level changes in the radiation reflected from the carrier when for example passing from written to unwritten region may cause such a change. Additionally, the geometrical shapes of written marks may also give rise to a transition within the context of the present invention. The written marks may for example be written with different laser power profiles that result in correspondingly different geometrical shapes of the marks. Thus, edges and corners of the written marks may vary.

Advantageously, the predetermined timeframe(s) (T1, T2) before said transition and/or after said transition may be shorter than a characteristic response time of the radial servomechanism. Preferably, the predetermined timeframe(s) (T1, T2) is/are significantly shorter than the response time of the radial servomechanism. Thus, predetermined timeframe(s) (T1, T2) may be about 1, 2, 3, 4, 5, 6, 7, 8, 9, or 10 microseconds. A response time may be defined as the time needed by the servomechanism to reach 90% of its final value after a step-like disturbance. The typical response time of a radial servomechanism is between 10 and 30 microseconds.

Typically, the optical drive according to the present invention may further comprise sampling means for sampling of indications of the amplitude (WA) of the wobble signal at a pre-determined sampling frequency. Such sampling means may be adapted to average over a pre-determined number of indications of the amplitude (WA) of the wobble signal. Thus, 1, 2, 3, 4, 5, 6, 7, 8, 9, 10 and more values indicative of the amplitude (WA) of the wobble signal may be exploited for obtaining an averaged value. Possibly, the average may be a running average in order to obtain a better precision of the adjusted gain. The sampling means may advantageously, upon an indication of a transition by the transition detection means, be adapted to store one or more indications of the amplitude (WA) of the wobble signal before the transition in order to be able to calculate the ratio (r) between a wobble amplitude (WA_b) within a predetermined timeframe (T1) just before said transition and a wobble amplitude (WA_a) within a predetermined timeframe (T2) just after said transition.

In a second aspect, the invention relates to a method for operating an optical drive capable of recording/reproducing data to/from an associated optical carrier, said optical carrier comprising data tracks with meandering pre-grooves adapted for generating wobble signals, the method comprises the steps of:

positioning a focused radiation beam on the optical carrier by control means,

detecting by photo detection means radiation reflected from the associated optical carrier, said photo detection means being adapted for generating a push pull signal (PP) indicative of a difference between a target position and an actual position of the focused radiation beam on the optical carrier,

controlling the radial position of the focused radiation beam on the optical carrier in response to said push pull signal (PP) by a radial servomechanism, said radial servomechanism comprising amplification means for amplifying said push pull signal by a variable gain (G),

detecting an indication of the amplitude (WA) of the wobble signal from the push pull signal (PP) by wobble signal detection means, and

assessing by transition detection means if the focused radiation beam has been exposed or will be exposed to a change in a local optical environment on the optical carrier,

wherein the method, upon an indication of a transition by the transition detection means, further comprises the step:

adjusting the radial servo gain (G) in dependence of a ratio (r) between a wobble amplitude (WA_b) within a predetermined timeframe (T1) just before said transition and a wobble amplitude (WA_a) within a predetermined timeframe (T2) just after said transition so as to obtain a substantially constant radial bandwidth of the radial servomechanism.

The invention according to the second aspect is particularly, but not exclusively, advantageous because it facilitates a fast and readily implementation of the invention due to the relatively small modifications of hitherto known optical drives that is required.

In a third aspect, the invention relates to a computer program product being adapted to enable a computer system comprising at least one computer having data storage means associated therewith to control an optical drive according to the second aspect of the invention.

This aspect of the invention is particularly, but not exclusively, advantageous in that the present invention may be implemented by a computer program product enabling a computer system to perform the operations of the second aspect of the invention. Thus, it is contemplated that some known optical drive may be changed to operate according to the present invention by installing a computer program product on a computer system controlling the said optical drive. Such a computer program product may be provided on any kind of computer readable medium, e.g. magnetically or optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

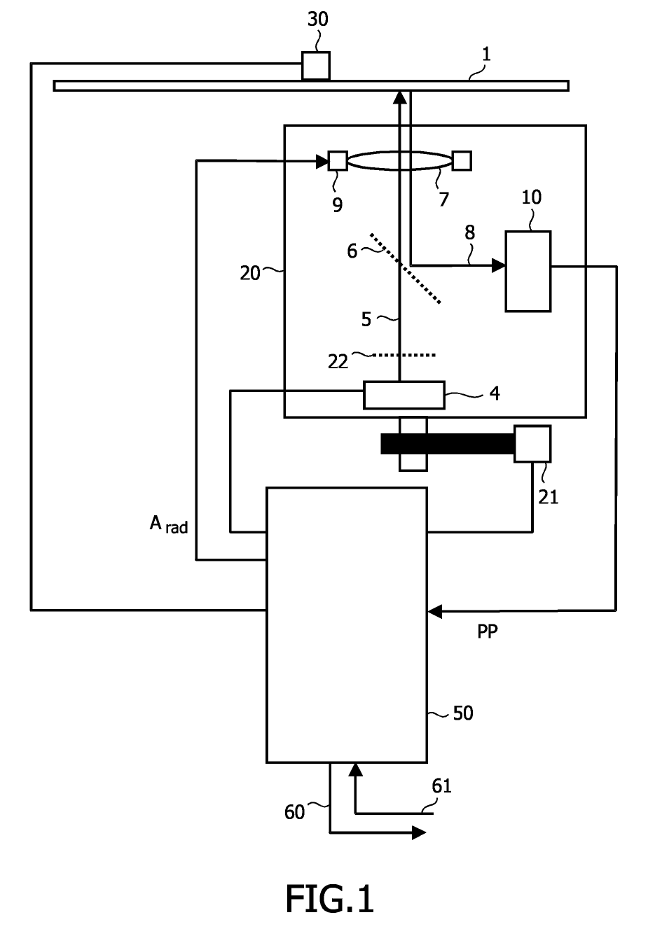

FIG. 1 is a schematic block diagram of an embodiment of an optical drive according to the invention,

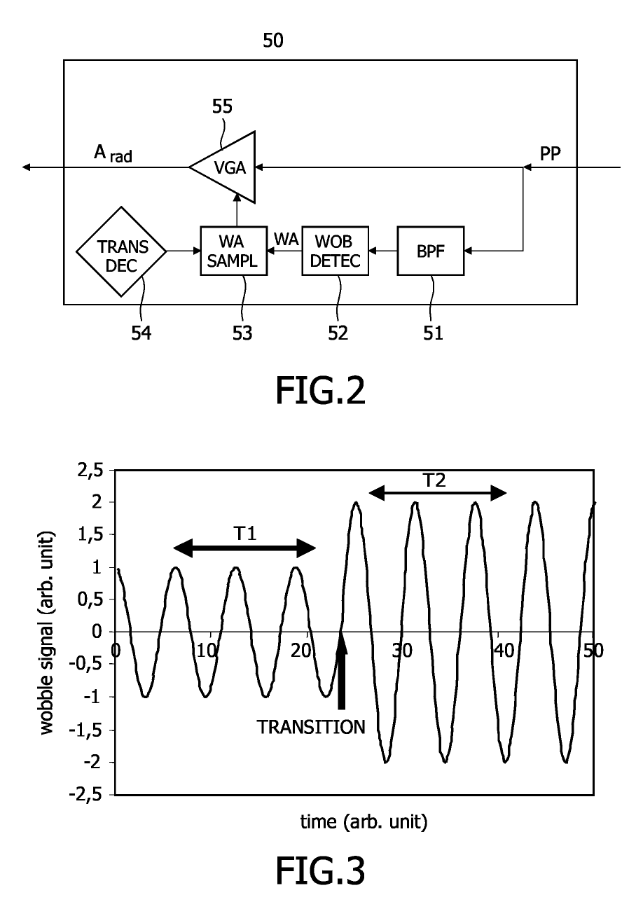

FIG. 2 is a block diagram illustrating selected parts of the radial servomechanism of an optical drive according to the invention,

FIG. 3 is a graph showing the wobble signal before and after a transition according to the present invention, and

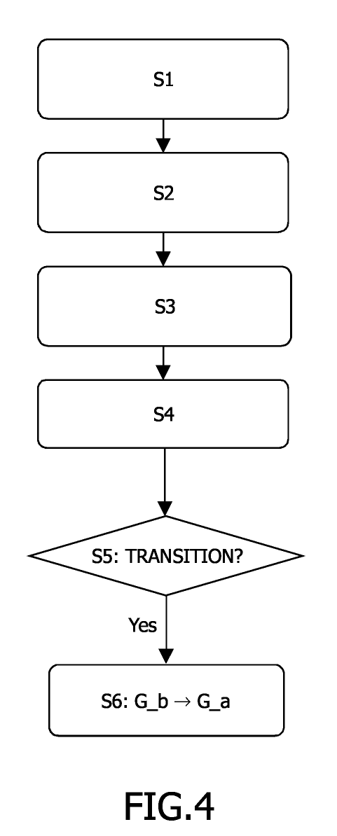

FIG. 4 is a flow-chart of a method according to the invention.

FIG. 1 is a schematic block diagram of an embodiment of an optical drive according to the invention. The optical carrier 1 is fixed and rotated by holding means 30.

The carrier 1 comprises a material suitable for recording information by means of a radiation beam 5. The recording material may be of, for example, the magneto-optical type, the phase-change type, the dye type, metal alloys like Cu/Si or any other suitable material. Information may be recorded in the form of optically detectable regions, also called marks for rewriteable media and pits for write-once media, on the carrier 1.

The apparatus comprises an optical head 20, sometimes called an optical pick-up (OPU), the optical head 20 being displaceable by actuation means 21, e.g. an electric stepping motor. The optical head 20 comprises a photo detection system 10, a radiation source 4, a beam splitter 6, an objective lens 7, and lens displacement means 9 capable of displacing the lens 7 both in a radial direction of the carrier 1 and in the focus direction. The optical head 20 may also comprise beam splitting means 22, such as a grating or a holographic pattern that is capable of splitting the radiation beam 5 into at least three components for use in the three spot differential push-pull radial tracking, or any other applicable control method. For clarity reason, the radiation beam 5 is shown as a single beam after passing through the beam splitting means 22. Similarly, the radiation 8 reflected may also comprise more than one component, e.g. the three spots and diffractions thereof, but only one beam 8 is shown in FIG. 1 for clarity.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals. The photo detectors are arranged spatially to one another, and with a sufficient time resolution so as to enable detection of error signals i.e. focus error FE signals and radial tracking error RE signals, such as a push pull PP signal obtained from a two-segmented photo detector. The focus FE and radial tracking error RE signals are transmitted to the processor 50 where commonly known servomechanism operated by usage of PID control means (proportional-integrate-differentiate) is applied for controlling the radial position and focus position of the radiation beam 5 on the carrier 1.

The photo detection system 10 can also output a read signal or RF signal representing the information being read from the carrier 1 to the processor 50. The read signal is obtained from the central aperture (CA), i.e. the RF signal is the high-frequency part of the central aperture signal CA. In general, the central aperture may be defined as CA=L+R, where L and R are the intensities of the left and right halves of the returning beam 8, respectively. Similarly, the push pull may be defined as PP=L−R, where L and R are the intensities of the left and right halves of the returning beam 8, respectively. The wobble signal is derived from the PP signal. In the context of the present invention, the photo detection system 10 and the processor 50 may be considered as forming part of the transition detection means because a transition from an unwritten to a written zone, or vice versa, on the carrier 1 is readily detected by the changes in the RF signal.

The radiation source 4 for emitting a radiation beam or a light beam 5 can for example be a semiconductor laser with a variable power, possibly also with variable wavelength of radiation. Alternatively, the radiation source 4 may comprise more than one laser.

The optical head 20 is optically arranged so that the radiation beam 5 is directed to the optical carrier 1 via a beam splitter 6, and an objective lens 7. Radiation 8 reflected from the carrier 1 is collected by the objective lens 7 and, after passing through the beam splitter 6, falls on a photo detection system 10 which converts the incident radiation 8 to electric output signals as described above.

The processor 50 receives and analyses signals from the photo detection means 10. The processor 50 can also output control signals to the actuation means 21, the radiation source 4, the lens displacement means 9, and the rotating means 30, as schematically illustrated in FIG. 2. Similarly, the processor 50 can receive data, indicated at 61, and the processor 50 may output data from the reading process as indicated at 60. As shown in FIG. 1, the processor 50 in particular receives a push pull signal PP and outputs a corresponding control signal A_{rad} to the lens displacement means 9 as a part of the radial servomechanism.

FIG. 2 is a block diagram illustrating selected parts of the radial servomechanism of the optical drive. Primarily, but not necessarily, the parts are positioned within the processor 50. To the right the PP signal is received in the processor 50 from the photo detection means 10. The PP signal may be normalized to the total received light in photo detection means 10 by normalizing means (not shown). The PP signal is amplified by a variable gain amplifier (VGA) 55 and a control signal A_{rad} on the left of the processor 50 for controlling the radial actuator 9. The amplifier 55 may form part of a PID control device of the radial servomechanism.

The variable gain amplifier 55 is adjusted by the wobble data channel shown in the lower part of the processor 50 in FIG. 2. Initially, the wobble signal is extracted from the PP signal by a band pass filter (BPF) 51. According to standards within the field a writeable compact disk (CD-R) should have a band pass filter 51 with a band component of 22±1 kHz in order to extract the wobble signal from the PP signal. Similarly, carrier formats of BD and DVD should have filters with DVD+R/RW: 812 kHz, DVD-R/RW: 140 kHz, BD-R/RE: 960 kHz, all at their respective 1× speeds according to the relevant wobble standards. After the filtering the wobble signal is analyzed by wobble detection means 52 to obtain in particular the wobble amplitude WA (e.g. by a peak detector circuit), which is sampled by wobble amplitude sampling means 53. The sampling is preferably performed at a pre-set sampling frequency during a timeframe T1 and stored in arrays of memory units of the last-in-last-out type. If the transition detection means 54 transmits a signal indicating that the focused radiation beam 5 has been exposed or will be exposed to a change in a local optical environment on the optical carrier 1 to the sampling means 53, a wobble amplitude WA_b before the transition is stored in the sampling means 53. Just after or immediately after the transition, the sampling means 53 sample a wobble amplitude WA_a during a timeframe T2 and calculates the ratio r between WA_b and WA_b in order to perform a gain adjustment according to the principles of the present invention by sending a corresponding gain adjustment signal to the variable gain amplifier 55.

FIG. 3 is a graph showing the sinusoidal wobble signal before and after a transition, the transition being marked by a bold arrow, for further illustration of the invention. On the vertical scale, the wobble amplitude WA_b is plotted in arbitrary units. On the horizontal scale, the time is plotted. Depending on the type of carrier 1 and carrier speed the period of the wobble signal is typically in the order of 0.1-100 microseconds. Thus, as seen in FIG. 3 there is a relative change in the wobble amplitude WA resulting in a two-fold increase of the amplitude of the wobble signal after the transition. Also illustrative timeframes T1 and T2 before and after the transition, respectively, are inserted for indicating that the sampling means 53 may obtain a wobble amplitude WA_a and WA_b preferably by an averaging procedure over a certain time. Possibly, the sampling means 53 may use a running average method. Alternatively or additionally, the wobble amplitude WA_a and WA_b may be averaged over a certain or pre-determined number of periods of the wobble signal.

FIG. 4 is a flow-chart of a method according to the invention. The method for operating the optical drive comprises the steps of:

S1: positioning a focused radiation beam 5 on the optical carrier by control means i.e. the actuator 9 for fine position of the radial position and a stepping motor 21 for coarse position.

S2: detecting by photo detection means 10 radiation reflected 8 from the associated optical carrier 1, said photo detection means being adapted for generating a push pull signal PP.

S3: controlling the radial position of the focused radiation beam 5 on the optical carrier 1 in response to said push pull signal PP by a radial servomechanism, said radial servomechanism comprising amplification means VGA 55 for amplifying said push pull PP signal by a variable gain G,

S4: detecting an indication of the amplitude WA of the wobble signal from the push pull signal PP by wobble signal detection means 51, 52, and 53, and

S5: assessing by transition detection means 54 if the focused radiation beam 5 has been exposed or will be exposed to a change in a local optical environment on the optical carrier 1, such as read-write transition initiated by the drive itself or a transition from a written to an unwritten region. If an indication of a transition is detected by the transition detection means 54, the step S6 is carried out. Thus, S6 is a decision step.

S6: adjusting the radial servo gain G in dependence of a ratio r between a wobble amplitude WA_b within a predetermined timeframe T1 just before said transition and a wobble amplitude WA_a within a predetermined timeframe T2 just after said transition so as to obtain a substantially constant radial bandwidth of the radial servomechanism. Thus, r=(WA_b/WA_a), cf. equation (1).

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical drive capable of recording/reproducing data to/from an associated optical carrier (1), said optical carrier comprising data tracks with meandering pre-grooves adapted for generating wobble signals, the optical drive comprising:
control means (9, 21) capable of positioning a focused radiation beam (5) on the optical carrier,
photo detection means (10) for detection of radiation reflected (8) from the optical carrier, said photo detection means being adapted for generating a push pull signal (PP) indicative of a difference between a target position and an actual position of the focused radiation beam on the optical carrier,
a radial servomechanism adapted to change the radial position of the focused radiation beam (5) on the optical carrier in response to said push pull signal (PP), said radial servomechanism comprising amplification means (55) for amplifying said push pull signal by a variable gain (G),
wobble signal detection means (51, 52, 53) adapted to obtain an indication of the amplitude (WA) of the wobble signal from the push pull signal (PP), and
transition detection means (54) capable of assessing if the focused radiation beam (5) has been exposed or will be exposed to a change in a local optical environment on the optical carrier (1),
wherein the optical drive, upon an indication of a transition by the transition detection means (5), is adapted to change the radial servo gain (G) in dependence of a ratio (r) between a wobble amplitude (WA_b) within a predetermined timeframe (T1) just before said transition and a wobble amplitude (WA_a) within a predetermined timeframe (T2) just after said transition so as to obtain a substantially constant radial bandwidth of the radial servomechanism.

2. An optical drive according to claim 1, wherein the adjusted radial servo gain (G_a) after said transition is substantially equal to the servo gain (G_b) before said transition multiplied by the said ratio (r).

3. An optical drive according to claim 1, wherein the adjusted radial servo gain (G_a) after said transition is further adjusted to be smaller than an upper limit value of the radial servo gain (G_max).

4. An optical drive according to claim 1, wherein the adjusted radial servo gain (G_a) after said transition is further adjusted to be larger than a lower limit value of the radial servo gain (G_min).

5. An optical drive according to claim 1, wherein the transition detection means (54) receives an indication that the focused radiation beam (5) will be exposed to a change in the local optical environment on the optical carrier (1) initiated by the optical drive itself.

6. An optical drive according to claim 1, wherein the transition detection means (54) receives an indication that the focused radiation beam (5) has been exposed to a change in the local optical environment on the optical carrier (1) from a relative change in the radiation reflected (8) from the optical carrier (1).

7. An optical drive according to claim 1, wherein the predetermined timeframe(s) (T1, T2) before said transition and/or after said transition is shorter than a characteristic response time of the radial servomechanism.

8. An optical drive according to claim 1, wherein the optical drive further comprises sampling means (53) for sampling of indications of the amplitude (WA) of the wobble signal at a pre-determined sampling frequency.

9. An optical drive according to claim 8, wherein the sampling means (53) are further adapted to average over a pre-determined number of indications of the amplitude (WA) of the wobble signal.

10. An optical drive according to claim 8, wherein the sampling means (53), upon an indication of a transition by the transition detection means (54), are further adapted to store one or more indications of the amplitude (WA) of the wobble signal before the transition.

11. A method for operating an optical drive capable of recording/reproducing data to/from an associated optical carrier (1), said optical carrier comprising data tracks with meandering pre-grooves adapted for generating wobble signals, the method comprises the steps of:
positioning a focused radiation beam (5) on the optical carrier by control means (9, 21),
detecting by photo detection means (10) radiation reflected from the associated optical carrier (1), said photo detection means being adapted for generating a push pull signal (PP) indicative of a difference between a target position and an actual position of the focused radiation beam on the optical carrier (1),
controlling the radial position of the focused radiation beam (5) on the optical carrier (1) in response to said push pull signal (PP) by a radial servomechanism, said radial servomechanism comprising amplification means (55) for amplifying said push pull signal by a variable gain (G),
detecting an indication of the amplitude (WA) of the wobble signal from the push pull signal (PP) by wobble signal detection means (51, 52, 53), and
assessing by transition detection means (54) if the focused radiation beam (5) has been exposed or will be exposed to a change in a local optical environment on the optical carrier (1),
wherein the method, upon an indication of a transition by the transition detection means (54), further comprises the step:
adjusting the radial servo gain (G) in dependence of a ratio (r) between a wobble amplitude (WA_b) within a predetermined timeframe (T1) just before said transition and a wobble amplitude (WA_a) within a predetermined timeframe (T2) just after said transition so as to obtain a substantially constant radial bandwidth of the radial servomechanism.

12. A computer program product being adapted to enable a computer system comprising at least one computer having data storage means associated therewith to control an optical drive according to the method according to claim 11.
